(19) United States
(12) Patent Application Publication
(10) Pub. No.: US 2022/0041367 A1
(43) Pub. Date: Feb. 10, 2022

(54) Insulated Cover for Consumer Product Containers

(71) Applicant: Deborah Urick, Southington, OH (US)

(72) Inventor: Deborah Urick, Southington, OH (US)

(21) Appl. No.: 17/375,294

(22) Filed: Jul. 14, 2021

Related U.S. Application Data
(60) Provisional application No. 63/060,700, filed on Aug. 4, 2020.

(51) Int. Cl. B65D 81/24; B65D 81/38; B65D 25/28

(52) U.S. Cl. CPC B65D 81/24; B65D 2203/10; B65D 25/28; B65D 81/38

(57) ABSTRACT

This present invention relates to an insulated cover for a perishable consumer product container. The insulated cover utilizes a neoprene material to provide insulation and prevent heat exchange for the perishable consumer product container stored within the cover to keep the contents cold and fresh for a longer period of time. The insulated cover further comprises a lid cutout and a handle cutout to make the lid and handle of the container available for a user. A slit at the bottom is used for inserting the container, and the insulated cover also has fasteners on its surfaces to easily secure the cover around the container.

### CROSS-REFERENCE TO RELATED APPLICATION

The present application claims priority to, and the benefit of, U.S. Provisional Application No. 63/060,700, which was filed on Aug. 4, 2020 and is incorporated herein by reference in its entirety.

### FIELD OF THE INVENTION

The present invention relates generally to the field of container covers. More specifically, the present invention relates to a removable and insulated cover for beverage or other consumer product containers that are used to keep milk, soft drinks, juices and other fluids cold and fresh. The insulated cover comprises a slit at the bottom end to accommodate the insertion of a container and includes one or more hook and loop fastening strips that are used to secure the cover around the container, while leaving the handle and the lid accessible to the user. More specifically, the cover comprises a neoprene material to provide insulation and maintain a waterproof characteristic for the cover, which keeps the milk, juice, or other fluid stored therein fresh for a longer period of time than without said cover. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, milk and other nutritional beverages offer many health benefits and are consumed by many people of all ages around the world. Usually, milk is packaged in plastic, paperboard or glass containers or jugs, and once the container is opened, the milk has a shelf life of around 4-7 days, if refrigerated. The milk is required to be stored at an appropriate temperature to keep the milk fresh for a long period of time. Generally, perishable food items, such as milk, should not sit out of the refrigerator or cooler for longer than one to two hours. During warmer weather, milk should not be kept out of the refrigerator or cooler for more than an hour, as after that time-frame bacteria beings to grow, thereby causing the milk to spoil and require its disposal.

In places where refrigerators or coolers are not easily accessible, for example, while travelling, on picnics, etc., people may have trouble keeping their milk and other perishable items cold and fresh for a long period of time. Keeping milk in conventional plastic, paperboard or glass containers or jugs does not maintain a required safe storage temperature for the contents of the container, causing the milk to spoil and essentially leaving the product unfinished, which becomes a waste of money. In such scenarios, people may then be unable to use the milk for themselves or their kids. Additionally, people may face problems in keeping other drinks and beverages cold without any refrigeration or available cooler devices.

There are various solutions available in the market to overcome these problems. For example, devices such as “koozies” are present, which is an insulating sleeve used to keep a canned or bottled drink cold. However, the standard koozies are smaller in size and cannot accommodate standard containers or jugs used to store milk or other beverages such as juice. Also, the koozies do not fully cover the container on which they are used, and fail to provide insulation to the food item stored inside the container, thereby causing the food item to be wasted if it becomes unsuitable for use.

Therefore, there exists a long felt need in the art for a removable, portable and reusable insulated cover for a beverage or consumer product container or jug, such as those used to store milk, other beverages or fluids or food. There is also a long felt need in the art for a cover that insulates the container or jug upon which it is placed, and keeps the milk or other food item, medicine or beverage stored therein fresh for a longer period of time. Additionally, there is a long felt need in the art for an insulated cover that can easily accommodate containers or jugs of varying sizes, and that enables the user to carry milk and other perishable consumer products to places where refrigeration capabilities are not present, without fear of premature spoilage. Furthermore, there is a long felt need in the art for an insulated cover that secures the container in a snug configuration, and allows the user to easily hold and transport the covered container. Finally, there is a long felt need in the art for an insulated cover for a beverage container or jug that is relatively inexpensive to manufacture, and that is both safe and easy to use.

The subject matter disclosed and claimed herein, in one embodiment thereof, comprises a multipurpose reusable insulating cover for a beverage container or jug. The insulating cover conforms and can be sized and configured to fit the shape and dimensions of the container or jug stored within the cover. The insulating further comprises a generally-rectangular cover with an exterior neoprene layer. The front surface of the cover has one or more hook fasteners, and the rear surface of the cover has corresponding overlapping loop fasteners which are fastened to the hook fasteners on the front cover to secure the container or jug effectively within the cover. The cover has a slit at the bottom to insert the container into the cover. The insulating cover has one or more access points, such as to provide an area for a lid and a handle for allowing the lid and handle of the jug or container to be easily grasped and used by an individual. The hook and loop fasteners allow the insulating cover to be secured to the beverage container for keeping the beverage cold and fresh for a longer time.

In this manner, the novel insulation cover of the present invention accomplishes all of the forgoing objectives, and provides a relatively efficient and convenient solution to keep milk and other fluids fresh and cold for longer periods of time. The insulation cover of the present invention accommodates a container having a perishable fluid such as milk, and insulates the container in order to maintain a required temperature to keep the stored milk, food item, medicine or other fluid cold and fresh. Additionally, the insulation cover is user-friendly as it allows people to carry milk and other similar food items to places where refrigerators or coolers are not easily accessible, and prevents the items from spoiling and being wasted.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose reusable insulating cover for a perishable item, such as a beverage container or jug. The insulating cover generally conforms to the shape and dimensions of the container or jug which is to be stored within the cover. The insulating cover further comprises a geometrically-shaped, such as a generally-rectangular cover, having an exterior neoprene layer. The front surface of the cover having one or more hook fasteners, and the rear surface of the cover having corresponding overlapping loop fasteners which are fastened to the hook fasteners to secure the container or jug effectively within the cover. The cover has a slit or other opening at the bottom to allow for insertion of the container into the cover. The insulating cover has one or more openings for a lid and a handle, as well as other features on the container to allow the lid and handle of the jug or container to be easily grasped by a user. The hook and loop fasteners allow the insulating cover to be secured over the beverage container for keeping the beverage cold and fresh for a longer time.

In a further embodiment of the present invention, an insulating milk koozie-type cover is disclosed. The cover includes a vertical bottom slit to allow the container to be easily wrapped in the cover. The cover has a plurality of hook and loop fasteners which act as overlapping flaps to secure the cover to the cover surface for allowing effective insulation properties. The cover is made up of an insulating material and includes an interior compressible foam layer such as a polyurethane foam and an exterior layer, such as neoprene or rubber, that provides for a water-proof layer and to further provide an insulation feature to the container housed within the cover. The cover has one or more cut-outs for the lid, nozzle, handle opening other container features. The insulation provided by the cover keeps milk, perishable items or any other beverage cold and fresh for a considerable period of time.

In a further embodiment of the present invention, the multipurpose insulating cover can be utilized with a variety of beverage or perishable-holding containers such as a container, jug or other device. The cover is insulating, machine-washable and reusable as per the requirements of the users. The cover acts as a barrier between the external heat and the container, thereby effectively providing the insulation to the beverage. The cover is configurable so as to be able to accommodate different-sized containers or other vessels that may hold the perishable item.

In a yet still further embodiment, an insulating cover for holding a beverage or perishable consumer item container is presented. The container comprises a nozzle or a lid and a handle, and is configured to store a beverage or other perishable consumer item such as food or medicine. The insulating cover is formed from a portion of neoprene material to provide insulating properties and has a front portion, a rear portion, a top portion and a bottom portion. Each of the front portion and the rear portion are connected to each other, and the bottom portion has a vertical slit which may extend the entire length or width of the cover, or may only extend a portion of the length or width such as one-third, one-half, two-thirds or other such configurations. The cover has a cutout for each of the nozzle, opening, handle and other features for easy grasping and use by an individual. The cover has a plurality of hook and loop fasteners which are connected to one another for the cover to be secured around the beverage or other consumer item container for effective insulation.

The insulating cover can be constructed using any insulating material such as silicone, rubber, neoprene or the like. The exact size, measurement, construction and design specifications of the insulating cover may vary upon further development and to suit user needs or manufacturing parameters.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an insulated cover for a consumer product container of the present invention in accordance with the disclosed architecture;

FIG. 2 illustrates a perspective view of one potential embodiment of an insulated cover for a consumer product container of the present invention in accordance with the disclosed architecture, wherein the cover is installed on a container;

FIG. 3 illustrates a perspective view of another potential embodiment of an insulated cover for a consumer product container of the present invention in accordance with the disclosed architecture;

FIG. 4 illustrates a perspective view of another potential embodiment of an insulated cover for a consumer product container of the present invention in accordance with the disclosed architecture, wherein the cover is installed on a container;

FIG. 5 illustrates a sectional cut-out view of the insulated cover for a consumer product container of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there is a long felt need in the art for a removable, portable and reusable insulated cover for a beverage container or jug, such as those used to store milk or other fluids. There is also a long felt need in the art for a cover that insulates the container or jug upon which it is placed, and keeps the milk or other food item, medicine or beverage stored therein fresh for a longer period of time. Additionally, there is a long felt need in the art for an insulated cover that can easily accommodate containers or jugs of varying sizes, and that enables the user to carry milk and other perishable consumer products to places where refrigeration capabilities are not present, without fear of premature spoilage. Furthermore, there is a long felt need in the art for an insulated cover that secures the container in a snug configuration, and allows the user to easily hold and transport the covered container. Finally, there is a long felt need in the art for an insulated cover for a beverage container or jug that is relatively inexpensive to manufacture, and that is both safe and easy to use.

The present invention, in one exemplary embodiment, is a novel multipurpose insulating cover for a perishable consumer item such as beverage container or jug. The insulating cover conforms to the shape and dimensions of the container or jug stored within the cover. The insulating further comprises a geometrically-shaped cover with an exterior neoprene layer, and interior compressible foam layer. The neoprene layer has a thickness ranging from 1/32″ to ⅜″, with about ¼″ being preferred. The cover may be manufactured from any suitable types of material including cloth such as canvas, sail cloth, muslin, denim, duck cloth, coated fabrics and combinations thereof. A front surface of the cover has one or more hook fasteners, and the rear surface of the cover has the corresponding overlapping loop fasteners which are fastened to the hook fasteners to secure and hold the container or jug effectively within the cover. The cover has a slit or opening at the bottom in order to allow insertion of the container into the cover. The insulating cover has one or more openings, such as a lid cutout and a handle cutout, for allowing the lid and handle of the jug or container to be easily grasped by a user. The hook and loop fasteners allow the insulating cover to be secured to the beverage container for keeping the perishable consumer item such as a beverage, medicine or food, cold and fresh for a longer time.

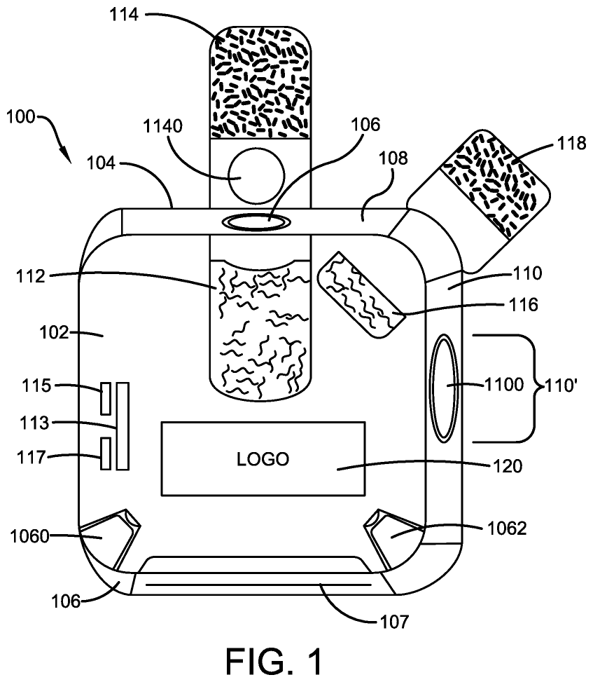

Referring initially to the drawings, FIG. 1 illustrates a perspective view of one potential embodiment of an insulated cover for a consumer product container 100 of the present invention in accordance with the disclosed architecture. More specifically, the multipurpose reusable and readily configurable insulation cover 100 may be used with a variety of different-sized containers that can be configured and dimensioned to correspond to the shape and dimensions of typical or standard-sized perishable consumer products such as milk jugs, medicine, food packaging and containers. For example, in one embodiment, the insulated cover 100 accommodates a conventional milk jug or container and provides insulation that keeps milk cold and fresh for a considerable period of time. The insulated cover 100 is relatively lightweight and conforms to the shape of the accommodated package, jug or container, and preferably has a single unit structure with a front surface 102 and a rear surface 104. A bottom surface 106 has a slit or opening 107, through which a jug or container can be inserted into the cover 100. The slit or opening may run the length of the cover panel or only a portion of the length or width, such as one-half, one-third or two-thirds. Additionally, two narrow slits 1060, 1062 are also present at the extreme ends of the base surface 106 for providing moisture-proof insulation.

To provide insulation to a jug or container having a perishable consumer product such as milk or any other drink, the insulated cover 100 has a layer of insulating material such as neoprene material. In the present embodiment, a ¾ inch layer of neoprene material is disposed over the cover 100. The layer of neoprene material is perfectly stitched to provide weatherproof insulation to the container or jug, and is also waterproof and forms a light and heat exchange barrier between the container held in the cover and the external environment. The top surface 108 of the cover 100 has a cut-out opening 109 that can be configured and dimensioned to correspond to the shape and dimensions of a lid or opening of the perishable consumer product, such as milk jugs and containers. A side surface 110 of the cover 100 has a handle opening 1100 configured and dimensioned to correspond to the shape and dimensions of handle of the consumer product, such as milk jugs and containers. The handle of the container or jug is easily accessed from the handle opening 1100 to carry the jug, consumer package or container.

To easily and effectively secure the cover around the consumer package, jug or container, a plurality of hook and loop fasteners and straps are present on the cover 100. The straps may be extensible so that they can be stretched, as a larger container or package is place within the cover. In addition, it should be understood that a container may also be a compressible bladder or collapsible package so that the straps exert a pressure on the container to assist in expelling the contents of the container from the container. In the present embodiment, the front surface 102 has a plurality of sewn-on or fixed-loop fasteners. A first loop fastener 112 is sewn longitudinally below the top opening 109. A corresponding hook fastener 114 having a cut-out 1140 configured and dimensioned as of the top opening 109 and attached to the rear surface 104 and is used as a flap and fastens to the first loop fastener 112 to secure the cover 100 around the entire container.

Similarly, a second loop fastener 116 may be sewn on near the top right corner of the front surface 102. A corresponding second hook fastener 118 attached to the rear surface 104 is used as a flap to fasten to the second loop fastener 116. It should be noted that any number of hook and loop fasteners can be used for securing the cover 100 around the entire container or jug. In addition, rather than sewing, the fastening strips may be applied to the cover by a permanent adhesive.

The cover 100 can include certain design indicia 120 or markings that allow identification of the cover 100. The design indicia 120 could be a company logo or brand, a team logo or design, a club's logo or brand, a user's name, or any form of advertising or marketing. The options for design indicia 120 are essentially limitless. The cover 100 may also be fitted with a thermometer 113 to allow the user to monitor the temperature of the internal contents. Alternatively, the cover could have a temperature sensor and indicator symbols, such as red 115 and green 117 indicator lights which would indicate whether the contents of the cover are still within an acceptable range of temperatures.

The material of the cover 100 conforms to the shape and dimensions of various consumer packages, jugs or containers, with the handle accessible from the opening 1100 in the cover. The opening 1100 may also have a flap 1101 which can be secured over the handle to aid in keeping the internal contents of the cover cool. The slit 107 prevents moisture and also helps in retaining the insulation properties of the cover 100. The cover 100 can incorporate a zipper or other similar openable element to permit easy placement of the jug from the slit 107.

In a further embodiment of the present invention, the insulated cover 100 of the present invention may further comprise a an RFID tag or other wireless communication module 130 embedded in the cover 100 or positioned along its top or bottom surfaces that may be wirelessly paired with a mobile application 140 on a remote electronic device 150, as best shown in FIG. 1. The RFID tag or other wireless communication module 130 may be powered by a battery 135 and may also be in communication with the thermometer or temperature sensor 113 to alert the user if the temperature rises above a certain level. The remote electronic device 150 may be, but it not limited to, a smartphone, smart watch, computer, tablet or the like.

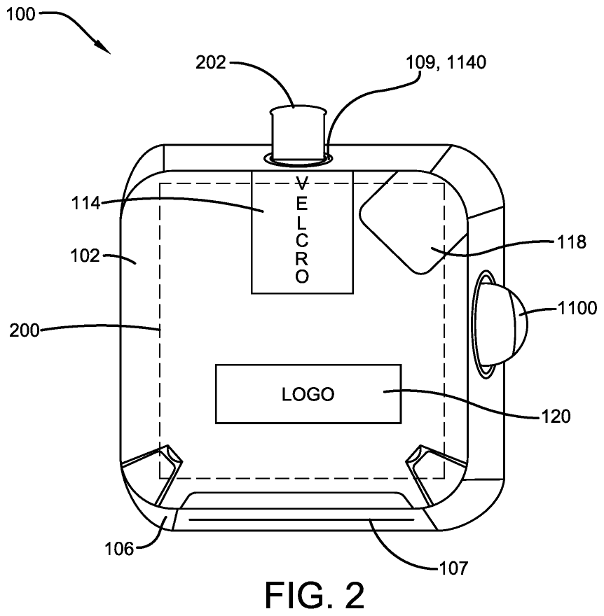

FIG. 2 illustrates a perspective view of one potential embodiment of an insulated cover for a consumer product container 100 of the present invention in accordance with the disclosed architecture, wherein the cover 100 is installed on a container 200. As shown, a container or package 200 is placed within the cover 100 and is inserted from the slit 107 at the bottom surface 106. When the jug or package 200 is secured within the cover 100, the lid or opening 202 of the jug or package 200 is positioned in the top opening 109, and the handle 204 of the jug 200 is accessible from the side opening 1100. The side cut-out 1100 allows the container handle 204 to be more fully exposed and readily grasped.

To secure the cover 100 around the jug 200, the hook on the flap 114 fastens to the front surface 102. The loop fastener present on the front surface 102 is used for fastening the flap 114. The cut-out hole 1140 of the flap 114 conforms and aligns with the top hole 109 when the jug 200 is placed within the cover 100. The flap 114 easily secures the cover 100 around the consumer package 200. Similarly, a second hook fastener flap 118 attaches to the front surface 102, thus conforming to the shape and contour of the consumer package 200.

The use of a material such as neoprene for the cover 100 provides an additional feature to the inventive multipurpose insulated cover 100, in that it provides some protection to the consumer package, jug or container from inadvertent impacts or simply being dropped. In addition, the neoprene serves to prevent light and heat exchange and creates a temperature barrier between the interior of the cover and the exterior environment. The cover 100 is flexible, dirt and scuff resistant, machine washable and can be manufactured in different sizes and shapes so that the covers could be used with different-sized consumer packages, fluid or drink containers.

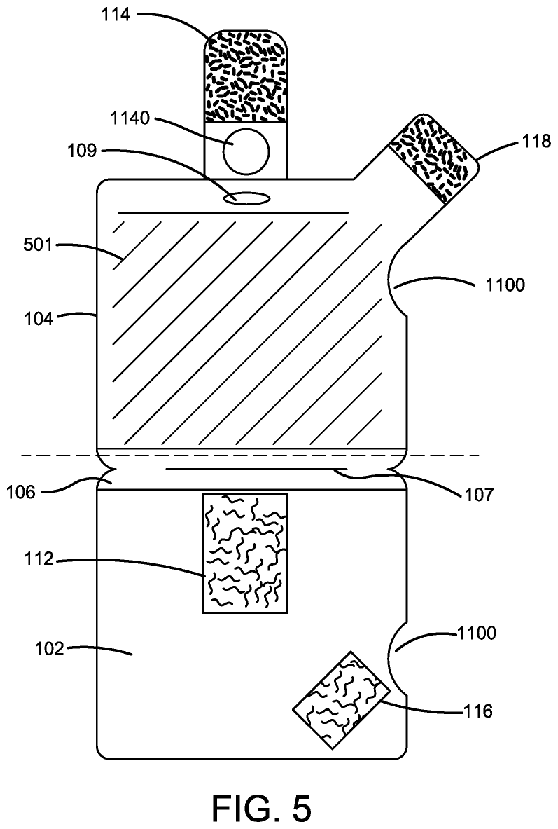

The cover 100 is flexible and can be configured to the shape and dimensions of the consumer package, jug or container 200 using the hook and loop strips to provide perfect insulation, keeping the consumer item cold and fresh for a considerable amount of time. The interior of the cover forms an insulation space 305 and may include a compressible foam material 501 (see FIG. 5) such as a polyurethane foam, which further provides an anti-slip feature to prevent the consumer package or container from falling out of the cover.

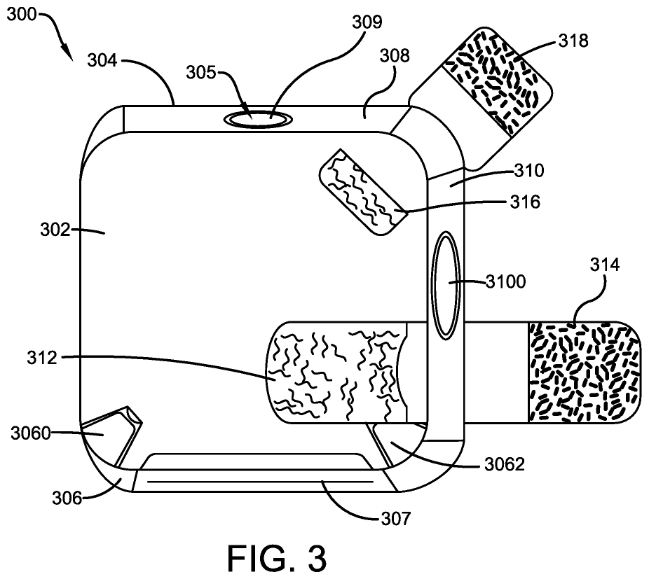

FIG. 3 illustrates a perspective view of another potential embodiment of an insulated cover for a consumer product container 300 of the present invention in accordance with the disclosed architecture. More specifically, the multipurpose insulation cover 300 of the present embodiment also has a front surface 302 and a rear surface 304. The front and rear surfaces 302, 304 define an interior space 305 for holding the consumer package or container. The front surface 302 has a first fastener 312 and a second fastener 316 sewn or adhesively attached to the front surface 302. An overlapping fastener-based flap 314 for the first fastener 312 is sewn or adhesively attached along an edge on the rear surface 304 and is used as a flap to fasten to the first fastener 312. The overlapping flap 314 conforms the cover 300 to the shape of a container stored within the cover 300. Similarly, a second fastener based flap 318 for the second fastener 316 is sewn or adhesively attached along an edge on the rear surface 304, and is used as a flap to fasten to the second fastener 316. The second flap 318 conforms the cover 300 to the shape of a container stored within the cover 300. The fasteners may be any suitable fasteners, such as hook and loop, adhesive closures (e.g. using a resealable adhesive that have mating parts to create a resealable closure) or other mechanical fasteners such as snaps, buttons, clasps or combinations of the foregoing.

The cover 300 of the present invention has a neoprene covering to provide insulation and waterproof characteristics and to create a barrier to light/heat exchange between the interior space of the cover and the external environment. The top surface 308 has a nozzle cover 309 for the lid, opening or nozzle of a jug, package or container. A side surface 310 has a handle cut-out 3100 for the grasping the handle of the jug, package or container. The bottom surface 306 has a slit 307 to receive any package, jug or container whose content is to be preserved and kept cold for a considerable amount of time. A pair of small slits 3060, 3062 prevent moisture from surrounding the package, container or jug within the cover 300.

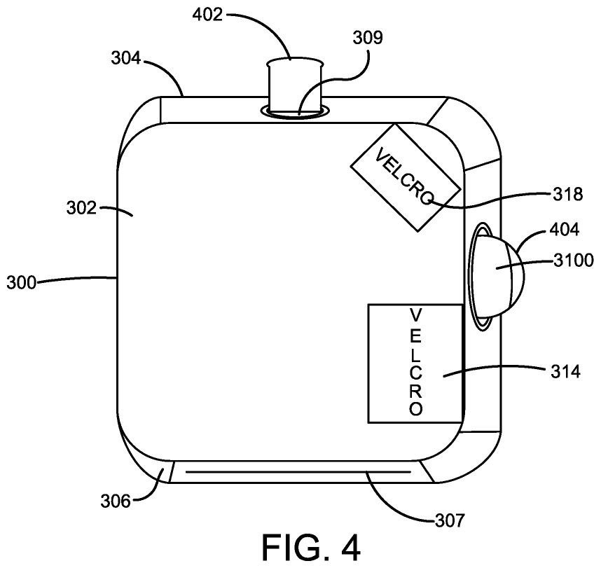

FIG. 4 illustrates a perspective view of another potential embodiment of an insulated cover for a consumer product container 300 of the present invention in accordance with the disclosed architecture, wherein the cover 300 is installed on a container 400. More specifically, the container 400 is inserted within the cover 300 through the slit 307. The container or the jug 400 is comfortably placed within the cover 300 with the handle 404 projecting outwards from the handle opening 3100 and the nozzle or the lid 402 projecting outwards from the top opening 309. To secure the container 400 within the cover 300 effectively, the overlapping loop flap 318 is fastened on the second hook fastener (see e.g., 316 in FIG. 3) to conform to the shape of the container 400. Similarly, to provide effective insulation such that the neoprene material covers the container completely, the overlapping loop flap 314 is fastened on the first hook fastener (see e.g., 312 in FIG. 3) to conform to the shape of the container 400.

The flexible nature of the material of the cover 300 allows the flaps 314, 318 to secure the container 400 and give a comfortable and effective wrapping around the container 400. The cover 300 provides thermal insulation characteristics to maintain the temperature of any fluid contained within the container 400. The flexible covers 100, 300 are shaped to fit snuggly over a one-gallon plastic milk or water container or jug. The covers 100, 300 are designed to cover the majority of the surface area of the containers inserted therein to provide the greatest insulation capability. Accordingly, as shown in FIGS. 1 and 3, the covers 100, 300 can have a slightly narrower top region as compared to the bottom sections of the cover 100, 300 and can also have rugged bottom surfaces.

Additionally, while the fastener portions illustrated in the embodiments of the present invention are conventional hook and loop-type fasteners, other adhesive or fastener types, such as mechanical fasteners, e.g., snaps, clasps, and the like, may of course be employed with the present invention. In an alternative embodiment of the present invention, the top surface or any side surface of the cover 100, 300 can have a strap, chain, string or cord affixed thereto for carrying the cover easily. Affixing means, such as a clamp, clasp, or clip, can be used to removably attach the strap or cord to the cover.

FIG. 5 illustrates a sectional cut-out view of the insulated cover for a consumer product container 100 of the present invention in accordance with the disclosed architecture. More specifically, the present embodiment shows the sectional view of the insulating cover 100 of FIGS. 1 and 2 in an open configuration. For use, the front portion 102 and the rear portion 104 are sewn, sealed or otherwise secured to each other and are configured to be of similar dimensions. The base 106 has a slit 107 from which a container can be inserted to the insulating cover 100. The rear surface 104 has first and second overlapping or cooperating fasteners 114, 118 that are positioned and dimensioned to attach to mating fasteners 112 and 116 present on the front surface 102. The handle cut-outs 1100 are present on both the rear surface 104 and the front surface 102, and coincide with each other when the insulating cover 100 is sewn. Additionally, the surfaces of the cover 100 are sewn along the edges of the front surface and rear surface and along the bottom surface 106. The lid opening 109 can be present on the rear surface 104 as shown, or may be present on the front surface 102 as well.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “insulation cover”, “insulated cover”, “multipurpose insulated cover”, “multipurpose insulation cover”, “insulated cover for containers”, “cover” and “multipurpose insulation cover for containers” are interchangeable and refer to the multipurpose insulated cover for a consumer product container 100, 300 of the present invention.

Notwithstanding the forgoing, the multipurpose insulated cover for a consumer product container 100, 300 of the present invention and its various components can be of any suitable size and configuration as is known in the art without affecting the overall concept of the invention, provided that they accomplish the above-stated objectives. One of ordinary skill in the art will appreciate that the size, configuration and material of the multipurpose insulated cover for a consumer product container 100, 300 as shown in the FIGS. are for illustrative purposes only, and that many other sizes and shapes of the multipurpose insulated cover for a consumer product container 100, 300 are well within the scope of the present disclosure. Although the dimensions of the multipurpose insulated cover for a consumer product container 100, 300 are important design parameters for user convenience, the multipurpose insulated cover for a consumer product container 100, 300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A consumer product carrier comprising:
a material having a front surface, a rear surface and a side surface, wherein the front, rear and side surface form an interior space that is sized and configured to receive a consumer product;
the material having a heat exchange barrier;
at least a first opening configured to access the consumer product; and
a fastener to secure the consumer product within the interior space.

2. The consumer product carrier as recited in claim 1, wherein the material is comprised of a neoprene layer.

3. The consumer product carrier as recited in claim 1 further comprising a second opening, a battery and a wireless communication module.

4. The consumer product carrier as recited in claim 3, wherein the second opening is for receipt of a handle on the consumer product.

5. The consumer product carrier as recited in claim 1, wherein the material includes a compressible foam layer in the interior space.

6. The consumer product carrier as recited in claim 3, wherein a flap is provided over each of the first and second openings.

7. The consumer product carrier as recited in claim 2, wherein the neoprene layer ranges from about 1/32″ to about ⅜″ in thickness.

8. The consumer product carrier as recited in claim 1, wherein the material is selected from one of a canvas, a sail cloth, a muslin, a denim, a duck cloth, a coated fabric and a combination thereof.

9. The consumer product carrier as recited in claim 3 further comprising at least one of a thermometer and a temperature sensor that is in communication with the wireless communication module.

10. The consumer product carrier as recited in claim 9, wherein the temperature sensor has an indicatory light.

11. The consumer product carrier as recited in claim 1, wherein the first opening receives a lid or opening of the consumer product.

12. An insulated carrier comprising:
a cover constructed from a material and having a waterproof coating on at least one side of the material;
the cover comprising a front surface, a rear surface and a pair of side walls defining an interior, wherein the interior is sized and configured to hold a container;
at least one of the pair of side walls having an opening therein for insertion of the container into the cover;
first and second fasteners secured to an exterior of the cover for securing the container within the cover; and
first and second openings in the cover to allow access to the container.

13. The insulated carrier as recited in claim 12, wherein the first and second fasteners are cooperating fasteners.

14. The insulated carrier as recited in claim 12, wherein the first and second fasteners are selected from a group consisting of a mechanical fastener and an adhesive fastener.

15. The insulated carrier as recited in claim 14, wherein the mechanical fastener is one of a hook and loop fastener or a cooperating male and female fastener.

16. The insulated carrier as recited in claim 13, wherein the first opening is for a lid of the container and the second opening is for a handle of the container.

17. The insulated carrier as recited in claim 13 further comprising a first closure flap for the first opening and a second closure flap for the second opening.

18. The insulated carrier as recited in claim 12, wherein the waterproof coating is comprised of a neoprene.

19. An insulated cover for a consumer product, the insulated cover comprising:
a cover having a neoprene layer on an exterior surface, and an interior space for holding a perishable consumer product container;
a slit at a bottom of the cover, the slit for inserting the perishable consumer product container in the cover;
a first opening in the cover for accessing a perishable consumer product contained within the perishable consumer product container;
a second opening for holding the perishable consumer product container;
a flap for each of the first and second openings, and
a pair of fasteners for securing the flap over each of the first and second openings.

20. The insulated cover for a consumer product as recited in claim 19, further comprising a wireless communication module and a battery, wherein the exterior surface of the cover has one of a thermometer and a temperature sensor, and further wherein the interior space includes a compressible foam material.
